(19) United States
(12) Patent Application Publication
(10) Pub. No.: US 2017/0302473 A1
(43) Pub. Date: Oct. 19, 2017

(54) METHOD OF TRANSMISSION OF A SIGNAL AND RING NETWORK

(71) Applicant: FUJITSU LIMITED, Kawasaki-shi (JP)

(72) Inventor: Yuji Tochio, Yokohama (JP)

(73) Assignee: FUJITSU LIMITED, Kawasaki-shi (JP)

(21) Appl. No.: 15/420,872

(22) Filed: Jan. 31, 2017

(30) Foreign Application Priority Data
Apr. 19, 2016 (JP) 2016-084059

(51) Int. Cl. H04L 12/437; H04L 12/707; H04L 12/24; H04L 12/713; H04L 12/46

(52) U.S. Cl. CPC H04L 12/437; H04L 45/586; H04L 12/4641; H04L 41/0668; H04L 45/22

(57) ABSTRACT

A method of transmission of a signal using a ring network that includes a plurality of transmission devices, any one transmission device of the plurality of transmission devices being set as a first blocking portion, and any another transmission device of the plurality of transmission devices being set as a second blocking portion, the method includes setting first information to a first signal, and transmitting the first signal from a first transmission device to a second transmission device, wherein when a value of the first information is a first value, the first blocking portion passes the first signal and the second blocking portion blocks the first signal, and when the value of the first information is a second value, the second blocking portion passes the first signal and the first blocking portion blocks the first signal.

### CROSS-REFERENCE TO RELATED APPLICATION

This application is based upon and claims the benefit of priority of the prior Japanese Patent Application No. 2016-084059, filed on Apr. 19, 2016, the entire contents of which are incorporated herein by reference.

### FIELD

A technology described in the present specification is related to a method of transmission of a signal and a ring network.

### BACKGROUND

At present, in each of the Internet and data center networks, communication is performed by using the Ethernet (registered trademark).

In the Ethernet, at a time of transmitting a signal, the signal is transmitted in accordance with a relationship between a destination and a transmitting port, stored in a table. In addition, in a case where a destination and a transmitting port are not established, the signal is transmitted by using a flooding method. Note that the flooding method is a method for transmitting a signal from all ports (all ports other than a receiving port in a case of relaying the signal).

Note that, in a method for storing, in the table, the relationship between the destination and the transmitting port, a relationship between a receiving port and a transmission source (a source address) is stored at a time of receiving a signal from another transmission device. Note that the receiving port and the transmitting port may be provided in, for example, the same interface card, thereby enabling a correspondence relationship therebetween to be acquired.

In addition, there is a ring network that couples, in a ring shape, transmission devices to configure the Ethernet. The ring network is a technology for forming an annular transmission path so as to string together the annular transmission path like beads and performing communication (end-to-end) between adjacent transmission devices, thereby providing signals (frames).

In such a ring network in the Ethernet, in order to avoid the occurrence of a loop at a time of switching a path or in order to perform high-speed switching, Ethernet ring protection (hereinafter, described as ERP) specified by ITU-TG.8032 is widely prevalent. As a technical literature of the related art, there is ITU-T, “ITU-T G.8032/Y.1344”.

### SUMMARY

According to an aspect of the invention, a method of transmission of a signal using a ring network that includes a plurality of transmission devices, any one transmission device of the plurality of transmission devices being set as a first blocking portion, and any another transmission device of the plurality of transmission devices being set as a second blocking portion, the method includes receiving, by a first transmission device of the plurality of transmission devices, a first signal, setting, by the first transmission device, first information to the first signal, and transmitting, from the first transmission device to a second transmission device plurality of transmission devices, the first signal in which the first information is set, wherein when a value of the first information is a first value, the first blocking portion passes the first signal and the second blocking portion blocks the first signal, and when the value of the first information is a second value, the second blocking portion passes the first signal and the first blocking portion blocks the first signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a ring network 10.

FIG. 2 is a diagram illustrating an example of a ring network 20.

FIG. 3 is a diagram illustrating an example of hardware configurations of transmission devices 100 in a first embodiment.

FIG. 4 is a diagram illustrating an example of functional block configurations of the transmission devices 100 in the first embodiment.

FIG. 5 is a diagram illustrating an example of a table stored in a storage unit 116 in the first embodiment.

FIG. 6 is a diagram illustrating an example of a table stored in the storage unit 116 in a second embodiment.

FIG. 7 is a diagram illustrating an example of a network 30 in which ring networks (Major-Rings) are coupled by a new ring network (a Sub-Ring).

FIG. 8 is a diagram illustrating an example of a network 40 in a third embodiment.

FIG. 9 is a diagram illustrating an example of functional block configurations of transmission devices 200 in the third embodiment.

FIG. 10 is a diagram illustrating an example of a flowchart to when one of the transmission devices 200, which serves as an owner, transmits, to corresponding ones of the transmission devices 200 within a ring network 23a, a control signal for configuring a ring network 23b.

FIG. 11 is a diagram illustrating an example of a flowchart in control before the corresponding ones of the transmission devices 200 receive the control signal, thereby configuring the ring network 23b.

FIG. 12 is a diagram illustrating an example of a frame format of a signal.

FIGS. 13A, 13B and 13C are diagrams illustrating examples of communication paths of signals in the network 40.

FIG. 14 is a diagram illustrating an example of a network 50 in a first example of a modification to the third embodiment.

FIG. 15 is a diagram illustrating an example of a network 60.

FIG. 16 is a diagram illustrating an example of a network 70 in a second example of a modification to the third embodiment.

### DESCRIPTION OF EMBODIMENTS

In the ERP specified in ITU-T G.8032/Y.1344, in order to avoid the occurrence of a loop of a signal within a network, a blocking port is installed. This is a technology for blocking some ports within a transmission device, thereby stopping transmission and reception of signals in a specific communication path.

However, by using the above-mentioned blocking port in a ring network, a communication path that is included in coupled communication paths and that is to be blocked is put into a state of not being used. In addition, a communication path established by receiving a signal turns out not to use a path related to the blocking port. In this manner, the application of the blocking causes communication bands in coupled communication paths to be difficult to fully use between ring networks, and accordingly, it is difficult to effectively use communication bands within the ring networks.

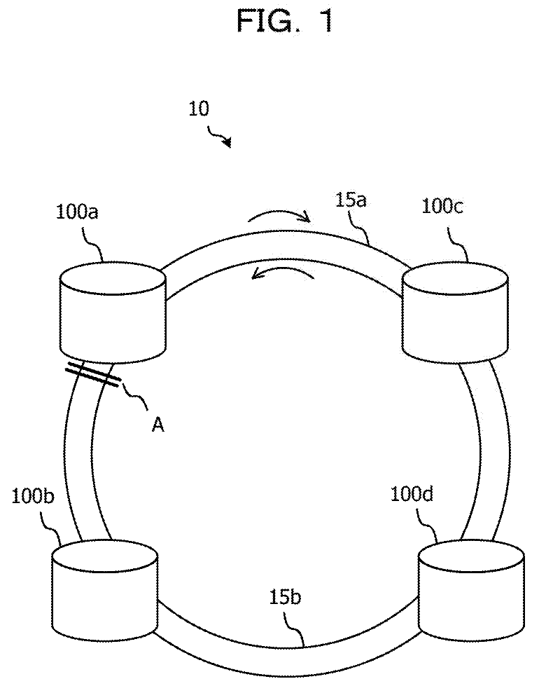

FIG. 1 illustrates an example of a configuration of the ring network 10. The ring network 10 includes transmission devices 100a, 100b, 100c, and 100d. In addition, in the ring network 10, by using a communication path 15a through which a signal is transmitted via the transmission devices 100a, 100c, 100d, and 100b in this order and a communication path 15b through which a signal is transmitted via the transmission devices 100a, 100b, 100d, and 100c in this order, signals are transmitted between the individual transmission devices 100.

In addition, between the transmission device 100a and the transmission device 100b, blocking is performed by a port of the transmission device 100a (hereinafter, the port is described as a blocking port), and in order to stop congestion of signals within the ring network 10, communication between the transmission device 100a and the transmission device 100b is stopped. Note that, in FIG. 1, a position of the blocking port is described as “A”.

Note that, in a case of not being distinguished from one another, the transmission devices 100a, 100b, 100c, and 100d are simply described as transmission devices 100.

In the ring network 10, the blocking port A causes communication to be difficult to perform between the transmission device 100a and the transmission device 100b. Therefore, a communication band between the transmission device 100a and the transmission device 100b is put into a state of being difficult to effectively use.

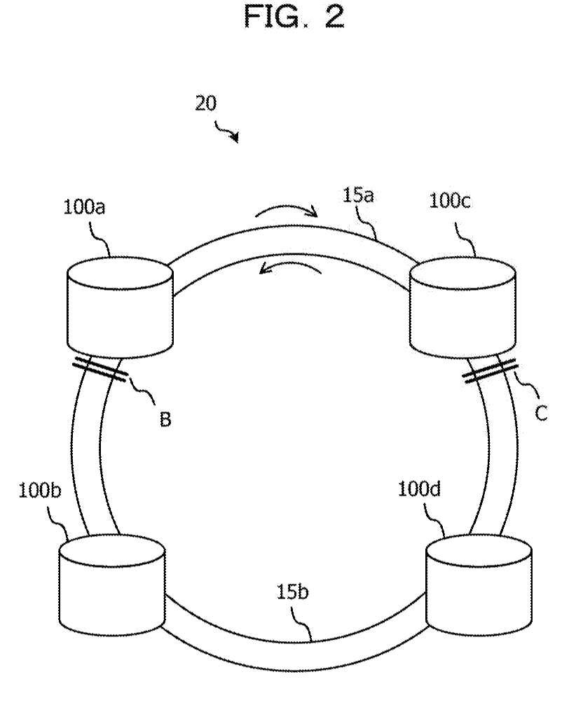

FIG. 2 illustrates the ring network 20 serving as an example of a configuration of the present disclosure. By using pieces of information assigned to signals in addition to the configuration of the ring network 10, the ring network 20 includes a blocking port in one of the transmission devices 100 for each of the pieces of information so that the pieces of information correspond to respective paths between different ones of the transmission devices 100.

Note that, by using the pieces of information assigned to the signals, a blocking port (B) and a blocking port (C) are installed, as blocking ports, in respective paths between the different ones of the transmission devices 100 in the ring network 20.

The blocking port (B) in the ring network 20 is located at the same position as that of the blocking port (A) in FIG. 1 and corresponds to a port of the transmission device 100a. The blocking port (C) in the ring network 20 is arranged between the transmission device 100c and the transmission device 100d and corresponds to a port within the transmission device 100c. Note that each of the blocking port (B) and the blocking port (C) is not limited to this and only has to be installed so as to be located between different ones of the transmission devices 100.

Regarding the blocking port (B) and the blocking port (C), blocking ports are installed in respective different ones of the transmission devices 100. Therefore, for each of the pieces of information assigned to the signals, a communication path to be subjected to blocking is different.

Accordingly, it is possible to effectively utilize communication bands for establishing couplings between the transmission devices 100.

In this way, different blocking ports are applied by using the pieces of information assigned to the signals, thereby enabling the coupled communication bands to be effectively utilized.

### First Embodiment

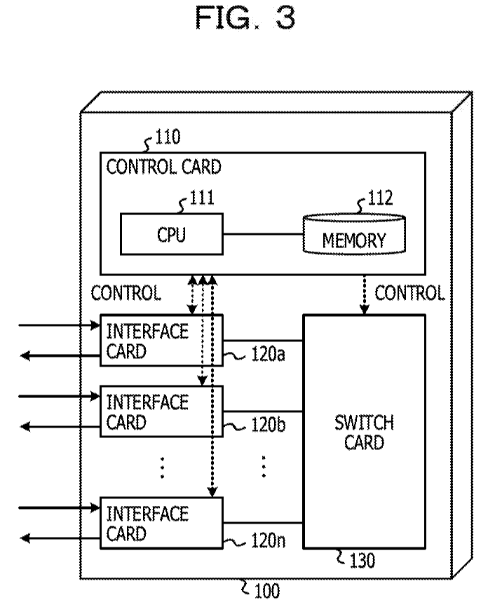

FIG. 3 illustrates one of hardware configuration diagrams of the transmission devices 100 in the first embodiment. Note that the first embodiment will be described by using the ring network 20 in FIG. 2. The transmission devices 100 each include a control card 110, interface cards 120a to 120n, and a switch card 130. Note that, in a case of not being distinguished from one another, the interface cards 120a to 120n are simply described as interface cards 120. In addition, every time the number of, for example, communication paths is physically increased, the interface card 120 is additionally installed.

The control card 110 is configured by a CPU 111 and a memory 112 and performs, on the interface cards 120 and the switch card 130, control including transfers of signals (frames) and instructions for installing blocking ports, for example.

The interface cards 120 each perform transmission and reception of signals to and from another device. A signal received by a corresponding one of the interface cards 120 is processed by the relevant interface card 120 and is transferred to the switch card 130. In addition, in a case where a signal to be transmitted is transferred by the switch card 130, a corresponding one of the interface cards 120 performs signal processing and performs transmission. Note that the signal processing in each of the interface cards 120 will be described later.

In a case where a signal is transferred by a corresponding one of the interface cards 120, the switch card 130 transfers, in accordance with control from the control card 110, the signal to a corresponding one of the interface cards 120, which serves as a transmission destination.

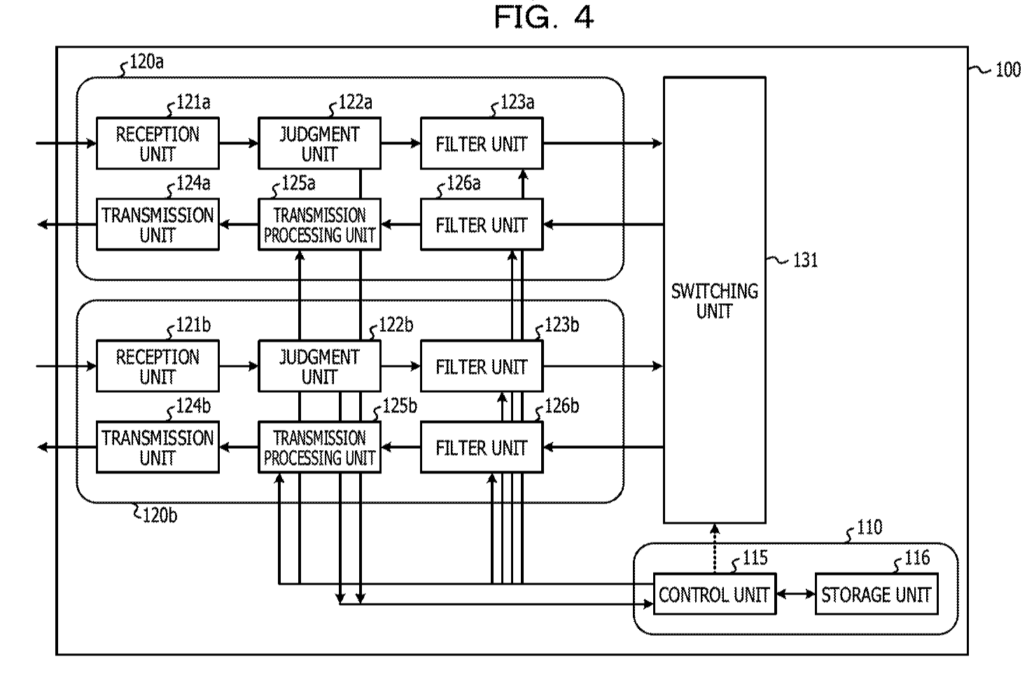

Next, FIG. 4 illustrates an example of functional block diagrams of the transmission devices 100 in the first embodiment. Note that since each of the transmission devices 100 is coupled to two of the transmission devices 100, the functional block diagram of one of the transmission devices 100 in FIG. 4 includes the two interface cards 120a and 120b corresponding to the number of physical communication paths.

The transmission devices 100 each include a control unit 115, a storage unit 116, reception units 121a and 121b, judgment units 122a and 122b, filter units 123a and 123b, transmission units 124a and 124b, transmission processing units 125a and 125b, filter units 126a and 126b, and a switching unit 131.

Note that, in a case of not being distinguished from each other, the individual functions (the reception units 121a and 121b, the judgment units 122a and 122b, the filter units 123a and 123b, the transmission units 124a and 124b, the transmission processing units 125a and 125b, and the filter units 126a and 126b) of the interfaces 120 are simply described only by using numeric characters (described as the reception units 121, the judgment units 122, the filter units 123, the transmission units 124, the transmission processing units 125, and the filter units 126).

The control unit 115 controls individual functions within the corresponding one of the transmission devices 100 by using information of the storage unit 116 and information of the judgment units 122. The control unit 115 controls, for example, filtering conditions in the filter units 123 and the filter units 126.

The storage unit 116 stores therein information used for each destination, ports of output destinations, and a blocking port in a case of serving as an owner transmission device 100. Note that the control unit 115 and the storage unit 116 correspond to the CPU 111 and the memory 112, respectively, in the control card 110 in FIG. 3.

Each of the reception units 121 receives and transfers a signal from another one of the transmission devices 100 to a corresponding one of the judgment units 122.

Each of the judgment units 122 judges based on information stored in a corresponding one of the received signals and sends a judgment result to the control unit 115. Note that the information to be judged includes, for example, information of a Virtual Local Area Network (VLAN) and information of a control signal, stored in a frame format of a signal.

In accordance with control from the control unit 115, the filter units 123 each perform filtering on a signal output by a corresponding one of the judgment units 122. The functions of the filter units 123 each correspond to control on a receiving side of a blocking port as described above and each stop a signal from a corresponding communication path in accordance with information judged by a corresponding one of the judgment units 122.

The transmission units 124 each transmit a signal transferred by a corresponding one of the transmission processing units 125, to a corresponding one of the other coupled transmission devices 100. In a case where the interface card 120a is coupled to another one of the transmission devices 100, the transmission unit 124a transmits a signal to the coupled transmission device 100, for example.

The transmission processing units 125 each perform, on a signal output by a corresponding one of the filter units 126, processing for transmission in accordance with control from the control unit 115. Operations, administration, and maintenance (OAM) information is assigned to the signal output by the corresponding one of the filter units 126, for example.

The filter units 126 each perform filtering on a signal output by a corresponding one of the switching units 131, in accordance with control from the control unit 115. The functions of the filter units 126 each correspond to control on a transmitting side of a blocking port as described above and each stop outputting a signal to a corresponding communication path, in accordance with information judged by a corresponding one of the judgment units 122.

The switching unit 131 transfers a signal received by each of the interface cards 120 to a corresponding one of the interface cards 120, which is to transmit the signal. Note that the switching unit 131 corresponds to the switch card 130 in FIG. 3.

Note that the interface cards 120 and the switch card 130 are each configured by, for example, an integrated circuit such as an application specific integrated circuit (ASIC) or a field programmable gate array (FPGA), or digital signal processing (DSP).

In addition, control of the filter units 123 and the filter units 126 is performed by a corresponding one of the transmission devices 100, which serves as an owner for each of pieces of information (for example, pieces of VLAN information) assigned to signals.

Control performed by each of the transmission devices 100 in the ring network 20 will be described. Note that while control of a blocking port will be described by using the VLAN, there is no limitation to this. In addition, an owner for a signal to which VLAN information (first VLAN information) corresponding to the blocking port (B) is assigned is the transmission device 100a, and an owner for a signal to which VLAN information (second VLAN information) corresponding to the blocking port (C) is assigned is the transmission device 100c.

Note that, in a case where a communication route is stored in the storage unit 116 when the corresponding one of the transmission devices 100 transmits a signal to another one of the transmission devices 100, the signal is transmitted based on information stored in the storage unit 116.

In addition, in a case where no communication route is stored in the storage unit 116, the corresponding one of the transmission devices 100 transmits a signal by using a flooding method.

A case where the transmission device 100a transmits a signal to the transmission device 100b in the ring network 20 will be used and described.

In a case where no signal paths are established when the transmission device 100a transmits, to the transmission device 100b, signals to which the first VLAN information and the second VLAN information are assigned, the signals are transmitted by using the communication paths 15a and 15b.

The signal to which the first VLAN information is assigned is routed through the transmission device 100c and the transmission device 100d and is received by the transmission device 100b. In addition, the relevant signal is subjected, based on the blocking port (B), to filtering by a corresponding one of the filter units 126 within the transmission device 100a between the transmission device 100a and the transmission device 100b and is not transmitted.

The signal to which the second VLAN information is assigned is received by the transmission device 100b without being routed through another one of the transmission devices 100. In addition, in a route routed through the transmission device 100c and the transmission device 100d, in a case where the transmission device 100c tries to transmit a signal to the transmission device 100d, the signal is blocked off by a corresponding one of the filter units 126 in the transmission device 100c. Accordingly, the signal is not transmitted to the transmission device 100d. Therefore, in the route routed through the transmission device 100c and the transmission device 100d in the second VLAN information, it is difficult for the transmission device 100b to receive the signal.

In other words, the signal to which the first VLAN information is assigned is routed through the transmission device 100c and the transmission device 100d and is received by the transmission device 100b, and the signal to which the second VLAN information is assigned is received by the transmission device 100b without being routed through another one of the transmission devices 100. In this way, the two communication paths exist within the ring network 20.

In this case, by using the two received signals, the control unit 115 in the transmission device 100b selects one of the two communication paths as a communication path between the transmission device 100a and the transmission device 100b and stores, in the storage unit 116, a port (a corresponding one of the interface cards 120), transmission destination information (the transmission device 100a in this case), and the VLAN information while associating the port (the corresponding one of the interface cards 120), the transmission destination information (the transmission device 100a in this case), and the VLAN information with one another. As a method for selection, a communication path having an earlier reception time or a communication path having a smaller number of the transmission devices 100 routed through is selected, for example. Note that, after establishing a path, transmission may be performed while assigning VLAN information different from the first VLAN information and the second VLAN information (alternatively, while assigning no VLAN information), and corresponding VLAN information does not have to be stored.

In addition, in the same way, the transmission devices 100 that relay the signals along the paths each store, in the storage unit 116, a port (one of the interface cards 120, which corresponds to the port), transmission source information (the transmission device 100a in this case), and the VLAN information while associating the port (one of the interface cards 120, which corresponds to the port), the transmission source information (the transmission device 100a in this case), and the VLAN information with one another. By doing so, a destination and a port (one of the interface cards 120) are stored while being associated with each other, thereby establishing a communication path. In addition, in a case of transmitting a signal having a destination for which a communication path is established, the signal is transmitted by using information in the storage unit 116.

After that, the transmission devices 100 each reference the storage unit 116 at a time of transmitting a signal and each transmit, from a corresponding one of the interface cards 120, the signal to which the VLAN information is assigned in accordance with a destination. In addition, the VLAN information assigned by the transmission device 100 serving as a transmission source is not rewritten within the ring network 20. In other words, the same VLAN information is used for each of signals in the same ring network 20.

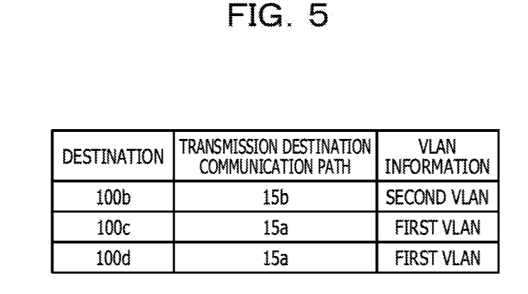

In addition, FIG. 5 illustrates an example of a storage table that is stored in the storage unit 116 and in which destinations, transmission destination communication paths (corresponding ones of the interface cards 120), and the pieces of VLAN information are stored while being associated with one another.

Note that the storage table illustrated in FIG. 5 indicates an example in which the transmission device 100a in the ring network 20 in FIG. 2 receives signals having transmission sources corresponding to the respective transmission devices 100b, 100c, and 100d and communication paths for the individual transmission devices 100 are established.

In this way, by using the first VLAN information and the second VLAN information within the ring network 20, it is possible to effectively utilize communication bands.

### Second Embodiment

The first embodiment indicates that, by using pieces of information assigned to signals, the communication bands of the ring network 20 are effectively utilized. In the second embodiment, a method for effectively utilizing bands by using communication paths will be illustrated.

In the same way as in the first embodiment, the second embodiment will be described by using the ring network 20 in FIG. 2.

Communication paths of signals will be described by using an example in which the transmission device 100a transmits signals to the transmission device 100d.

In a case where a communication path of a signal to which the first VLAN information is assigned is not established from the transmission device 100a to the transmission device 100d, the transmission device 100a assigns, at a time of transmitting a first signal, the first VLAN information thereto and transmits the first signal to each of the communication paths 15a and 15b. Note that since filtering is performed based on a corresponding one of the filter units 126, transmission is not performed in the communication path 15b. Accordingly, a communication route corresponding to the first VLAN information is established in the transmission device 100d and the transmission device 100c.

In addition, in a case where a communication path of a signal to which the second VLAN information is assigned is not established from the transmission device 100a to the transmission device 100d, the transmission device 100a assigns, at a time of transmitting a second signal, the second VLAN information thereto and transmits the second signal to each of the communication paths 15a and 15b. Note that since a signal in the direction of the transmission device 100d is subjected to filtering by a corresponding one of the filter units 126 in the transmission device 100c, a signal that uses the communication path 15a and to which the second VLAN information is assigned is not received by the transmission device 100d. Accordingly, a communication route corresponding to the second VLAN information is established in the transmission device 100b and the transmission device 100d. Note that, regarding each of the transmission devices 100 that perform reception until blocking is performed by the blocking ports, a transmission source and a port may be stored while being associated with each other. This causes a period of time before a route setting of the entire ring network 20 to be shortened.

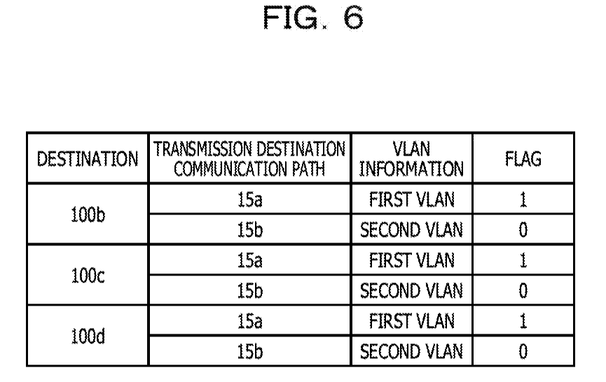

Note that, in a case of receiving signals from the respective other transmission devices 100, pieces of VLAN information and communication paths corresponding to the interface cards 120 of transmission destinations are stored, for each of destinations, in the storage unit 116 in a corresponding one of the transmission devices 100 while being associated with each other, as illustrated in FIG. 6. In other words, communication routes are established for each of the destinations.

In addition, in a case of transmitting a subsequent signal, the VLAN information used for each signal is changed under a predetermined condition, and the signal is transmitted by the interface card 120 corresponding to a transmission destination communication path corresponding to the assigned VLAN information. In addition, regarding the predetermined condition, the pieces of VLAN information are alternately used and selected or and selected by using a random function, for example. Note that, by putting, for each of destinations by use of flags described in FIG. 6, a mark of the VLAN information to be subsequently used for the relevant destination, it is possible to select the interface card 120 corresponding to both the VLAN information and a transmission destination communication path, based on the flags and the destinations.

As described above, by changing a communication route used every time a signal is transmitted, it is possible to effectively utilize communication bands. In addition, at a time of establishing a communication route, it is possible to reduce the number of times a duplicate copy of a signal is made.

### Third Embodiment

In the first and second embodiments, control in the single ring network 20 is described. In the third embodiment, an example of applying to a ring network that couples ring networks to each other will be described.

As the ring network that couples ring networks to each other, a network obtained by coupling ring networks (Major-Rings) specified by ITU-T G.8032/Y.1344 by use of a new ring network (a Sub-Ring) will be used and be described.

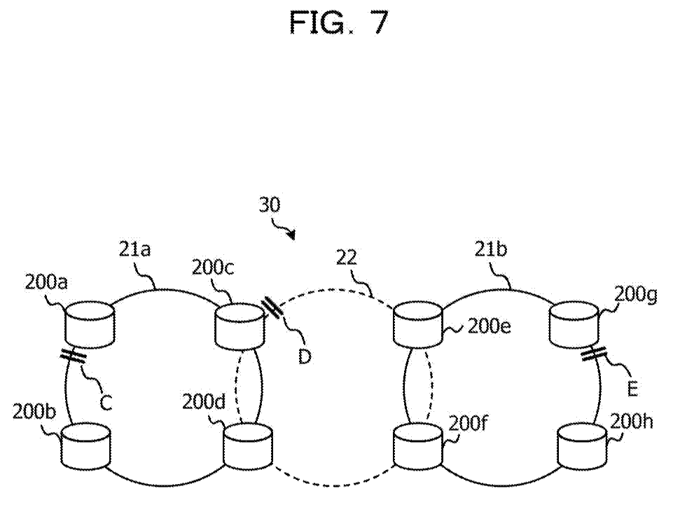

FIG. 7 illustrates an example of a configuration of the network 30 configured by a ring network (a Sub-Ring) coupling ring networks (Major-Rings) to each other. The network 30 includes a ring network (a Major-Ring) 21a, a ring network (a Major-Ring) 21b, and a ring network 22 (a Sub-Ring). Note that, in a case of not being distinguished from each other, the ring network 21a and the ring network 21b are simply described as ring networks 21.

The ring network 21a includes transmission devices 200a to 200d. In addition, in the ring network 21a, blocking between the transmission device 200a and the transmission device 200b is performed by a blocking port of the transmission device 200a, and communication between the transmission device 200a and the transmission device 200b is stopped. Note that if it is assumed that the transmission device 200a is an owner of, for example, the ring network 21a, a method for stopping communication is realized by installing a blocking port (C), based on control within the transmission device 200a serving as the owner.

If it is assumed that a transmission device 200g is an owner of, for example, of the ring network 21b, the ring network 21b is realized by installing a blocking port (E), based on control within the transmission device 200g serving as the owner.

The ring network 22 includes transmission devices 200c to 200f. In addition, in the ring network 22, provision of a blocking port (D) is set on a port side coupled to the transmission device 200e, based on control performed by the transmission device 200c. Note that the ring network 22 is a ring network for coupling the ring network 21a and the ring network 21b to each other and provides a sub-ring (a Sub-Ring) indicated by G.8032. In addition, a communication path between the transmission device 200c and the transmission device 200d and a communication path between the transmission device 200e and the transmission device 200f each form a shape of being virtually included as a configuration element of a ring (are each the same line as that of a corresponding one of the Major-Rings), and these communication paths are called virtual links (Virtual Links: VLs). Note that, in a case of not being distinguished from one another, the transmission devices 200a to 200h are simply described as transmission devices 200.

In the network 30, the blocking port (D) based on the ring network 22 inhibits communication between the device 200c and the transmission device 200e from being performed, and communication between the ring network 21a and the ring network 21b is only performed between the transmission device 200d and the transmission device 200f. In such a ring network 22 that couples the ring networks 21 to each other, blocking makes it difficult to effectively utilize communication bands (between the transmission device 200c and the transmission device 200e).

In addition, between the transmission device 200c and the transmission device 200d and between the transmission device 200e and the transmission device 200f, communication paths of the respective ring network 21a and ring network 21b are used. Therefore, in a case where the ring network 22 controls, the ring network 21a and the ring network 21b are influenced, and accordingly, it is difficult to control. In the ring network 22, it is desirable to install a blocking port between the transmission device 200c and the transmission device 200e or between the transmission device 200d and the transmission device 200f.

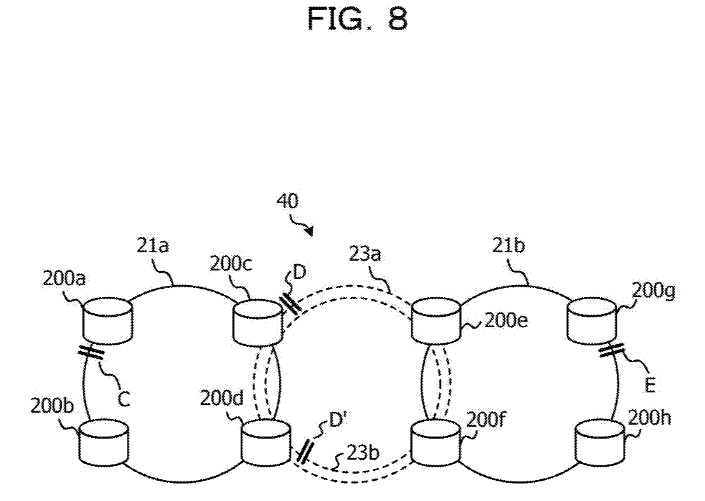

FIG. 8 illustrates an example of a configuration of the network 40 in the third embodiment. Note that, in FIG. 8, the same symbol is used for the same configuration as that of the network 30 in FIG. 7.

The network 40 has a configuration in which ring networks 23a and 23b that each couple the ring network 21a and the ring network 21b to each other each perform different control, depending on information of a signal. Note that, in a case of not being distinguished from each other, the ring networks 23a and 23b are simply described as ring networks 23. In addition, the ring network 23a and the ring network 23b use the same line, and different control is performed depending on information assigned to a signal.

In the same way as the ring network 22 in FIG. 7, the ring network 23a installs and controls the blocking port (D) in the transmission device 200c. The ring network 23b installs and controls a blocking port (D′) in the transmission device 200d.

In addition, the ring network 23a and the ring network 23b are distinguished by using, for example, a virtual local area network (VLAN).

In this way, in the ring networks 23 to couple the ring network 21a and the ring network 21b to each other, the congestion of a signal (or a frame loop) is avoided by using a blocking port different for each of rings (each of the ring network 21a and the ring network 21b) corresponding to the VLAN information, and it is possible to effectively utilize bands.

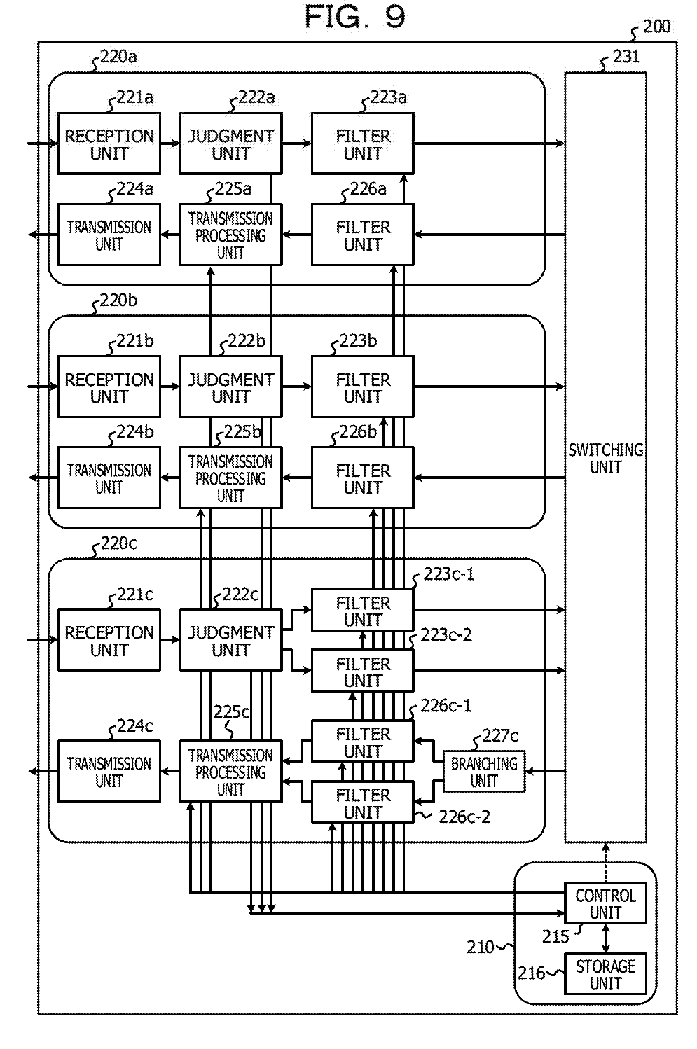

Next, FIG. 9 illustrates an example of functional block diagrams of the transmission devices 200 in the third embodiment. Note that the functional block diagram of the transmission device 200 in FIG. 9 illustrates a functional block diagram corresponding to each of the transmission device 200c to the transmission device 200f coupled to the ring networks 21 and the ring networks 23 in FIG. 8. Therefore, three interface cards 220a to 220c corresponding to the number of physical communication paths are included. In addition, in each of the other transmission devices 200, functions corresponding to the interface cards 220 are increased or decreased as appropriate. In addition, the interface card 220a and the interface card 220b indicate couplings within the ring network 21a, in other words, a case of being coupled to the transmission devices 200 that perform communication between Major-Rings, and are equal to the interface cards 120a and 120b in the transmission device 100 in FIG. 4. On the other hand, the interface card 220c indicates couplings within the ring networks 23, in other words, a case of being coupled to the transmission devices 200 that perform communication between Sub-Rings.

Since part of processing is different depending on whether between Major-Rings or between Sub-Rings, this is separated. In this regard, however, the interface card 220c may be used for each of all the interface cards 220.

In addition, a judgment may be performed for each of signals received by using the interface card 220a in place of the interface card 220c.

The corresponding one of the transmission devices 200 includes a control unit 215, a storage unit 216, reception units 221a to 221c, judgment units 222a to 222c, filter units 223a, 223b, 223c-1, and 223c-2, transmission units 224a to 224c, transmission processing unit 225a to 225c, filter units 226a, 226b, 226c-1, and 226c-2, a branching unit 227c, and a switching unit 231.

Note that, in a case of not being distinguished from each other, the individual functions (the reception units 221a to 221c, the judgment units 222a to 222c, the filter units 223a, 223b, 223c-1, and 223c-2, the transmission units 224a to 224c, the transmission processing units 225a to 225c, and the filter units 226a, 226b, 226c-1, and 226c-2, and the branching unit 227c) in the individual interfaces 220 are simply described only by using numeric characters (described as reception units 221, judgment units 222, filter units 223, transmission units 224, transmission processing units 225, filter units 226, and a branching unit 227). In addition, in a case of not being distinguished from each other, the filter units 226c-1 and 226c-2 are simply described as filter units 226c.

In addition, since the control unit 215, the storage unit 216, the reception units 221, the judgment units 222, the filter units 223, the transmission units 224, the transmission processing units 225, and the switching unit 231 are the same as the control unit 115, the storage unit 116, the reception units 121, the judgment units 122, the filter units 123, the transmission units 124, the transmission processing units 125, and the switching unit 131 in FIG. 4, respectively, the descriptions thereof will be omitted.

The filter units 226a and 226b are the same as the filter units 126 in FIG. 4. In accordance with control from the control unit 215, the filter unit 226c performs filtering on a signal output by the branching unit 227c. The functions of the filter units 226 each correspond to control on a transmitting side of a blocking port as described above and each stop outputting a signal to a corresponding communication path.

The branching unit 227c makes duplicate copies (two in a case of FIG. 6) of a signal transferred by the switching unit 231 and assigns different pieces of information (for example, VLANs) to the duplicate signals, thereby transferring the duplicate signals to the filter units 226c corresponding to the respective assigned pieces of information. Note that, as a method for assigning the different pieces of information (VLANs) to the signals, information of one of the two signals is set to information (a first VLAN) of a sent signal and information of the other is switched to information (a second VLAN) different from the information of the sent signal, for example. Note that switched information (a third VLAN) may be used without using the information (the first VLAN) of the sent signal.

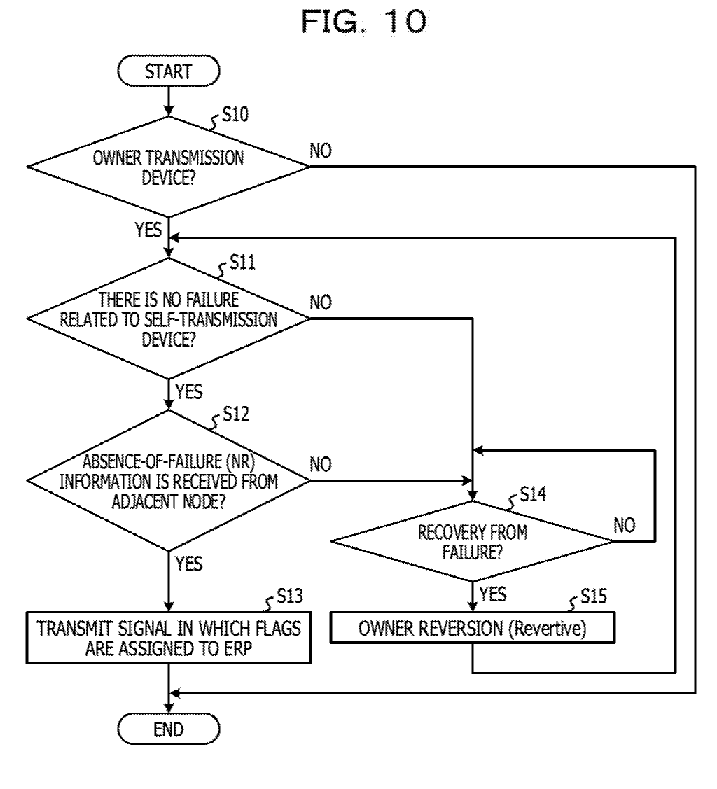

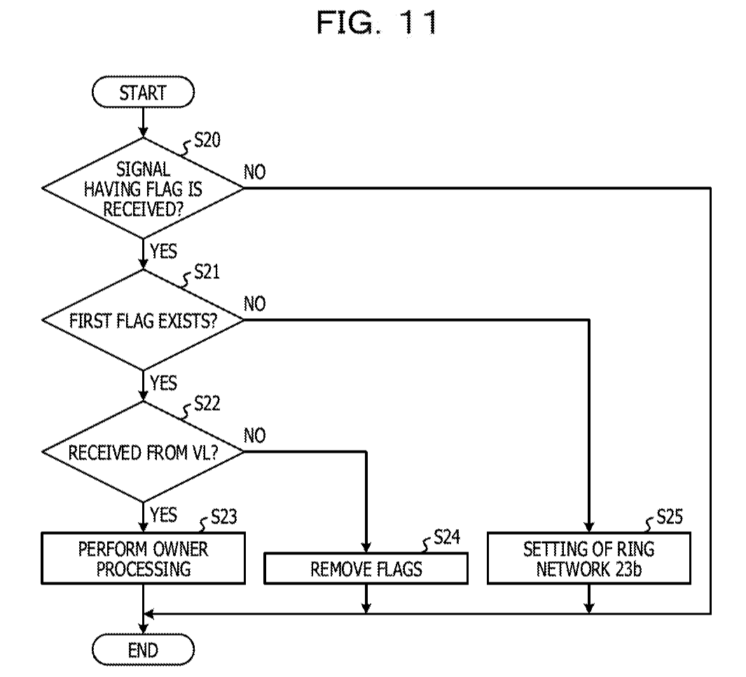

Next, by using FIG. 10 and FIG. 11, a method for forming the ring networks 23 by use of two different VLANs will be described.

Note that, in each of FIG. 10 and FIG. 11, it is assumed that an owner in the ring network 23a in the network 40 in FIG. 8 is the transmission device 200c. In addition, in the following description, an explanation will be provided under the assumption that VLANs are used as information for distinguishing the ring networks 23.

FIG. 10 illustrates a flowchart to when one of the transmission devices 200, which serves as an owner, transmits, to corresponding ones of the transmission devices 200 within the ring network 23a, a control signal for configuring the ring network 23b.

In accordance with ITU-T G.8032, the ring network 23a to couple the ring network 21a and the ring network 21b to each other is configured. Each of the transmission devices 200 confirms whether the self-transmission device 200 is the transmission device 200 serving as an owner in the ring network 23a (step S10). Note that the transmission device 200 to serve as the owner is preliminarily set under a predetermined condition. Note that, regarding a setting under the predetermined condition, a network administrator preliminarily performs the setting, as an example.

In a case where the self-transmission device 200 is the owner (step S10: Yes), the presence or absence of failure information related to the self-transmission device 200 is examined (step S11). Note that the presence or absence of failure information is examined based on the presence or absence of reception of a control signal between the coupled transmission devices 200, as an example. In addition, in a case where the self-transmission device 200 is not the owner (step S10: No), the processing is terminated.

In a case where no failure information exists in the self-transmission device 200 (step S11: Yes), it is examined whether NR information indicating the absence of failure information is received from one of the adjacent transmission devices 200 (one of the coupled transmission devices 200) by using the control signal (step S12).

In addition, in a case where the failure information exists in the self-transmission device 200 (step S11: No), the processing shifts to step S14.

In a case where the NR information is received (step S12: Yes), a signal in which flags for configuring the ring network 23b are assigned to the control signal is transmitted (step S13). Note that, as the flags for configuring the ring network 23b, there are an owner instruction flag (a first flag) and a flag (a second flag) indicating the implementation of the ring network 23b. Note that, as an example of the flag (the second flag) indicating the implementation, a VLAN Active Flag is cited. Note that, as an example of a method for storing the flags, an empty space in a frame format of the signal is used.

In addition, in a case where no NR information is received (step S12: No), in other words, in a case where there is failure information related to another one of the transmission devices 200 configuring the ring network 23a, the processing shifts to step S14.

In a case where there is failure information in one of the transmission devices 200 configuring the ring network 23a, a recovery is confirmed (step S14), and in a case where there is no recovery, a recovery is waited for (step S14: No). Note that, during the waiting, the ring network 23a is defined as a ring network in which a blocking port is formed by one of the transmission devices 200 so that a communication path in which a failure occurs is subjected to blocking.

In a case where failure information in each of the transmission devices 200 disappears (step S14: Yes), a reversion to the owner is performed (step S15), and the processing operation in step S11 is performed. Note that, as an example of the reversion to the owner, information indicating that failures disappear from the other transmission devices 200 is received, thereby performing the reversion, for example. Note that, regarding the information indicating that failures disappear from the other transmission devices 200, it is possible to determine by receiving the NR information indicating the absence of a failure.

In this way, the transmission device 200 to serve as the owner transmits, to the adjacent transmission devices 200, the control signal for configuring the ring network 23b.

FIG. 11 is a flowchart illustrating an operation of each of the transmission devices 200 at a time of receiving a control signal having a flag.

Upon receiving the signal, a corresponding one of the transmission devices 200 examines whether or not the signal is a signal having a flag (step S20). Note that it is assumed that, as flags in the flowchart in FIG. 11, there are the first flag and the second flag, described in FIG. 10. In addition, the judgment unit 222 judges whether being a signal having a flag.

In a case where a signal having a flag is received (step S20: Yes), it is examined whether the signal has the first flag (step S21).

In addition, in a case where no signal having a flag is received (step S20: No), the processing is terminated without performing control related to the configuration of the ring network 23b.

In a case where the first flag is received (step S21: Yes), a communication path from which the first flag is received is examined. Note that, as a method for examining, it is examined whether or not the signal is received from a line (a Virtual Link: VL) identical to those of the ring networks 23 and one of the ring networks 21 (step S22).

In addition, in a case where no first flag is received (step S21: No), in other words, in a case where only the second flag is received, a setting of the ring network 23b is performed (step S25). Note that, regarding a setting of the ring network 23b, a new VLAN different from the ring network 23a is assigned and is provided, for example.

In a case where the signal is received from a line (a VL) identical to those of the ring networks 23 and one of the ring networks 21 (step S22: Yes), processing as the owner of the ring network 23b is performed (step S23). The processing as the owner is a setting of a blocking port, as an example.

In addition, in a case where the signal is not received from a line (a VL) identical to that of one of the ring networks 21 (step S22: No), the flags are removed (step S24), and the processing is terminated.

Note that, in a case where the owner processing is performed (step S23) or processing for a setting of the ring network 23b (step S25) is performed, the information of the second flag is assigned to a signal to be transmitted to a path of the ring networks 23, different from a communication path from which reception is performed, and the signal is transmitted.

By doing so, in all the transmission devices 200 configuring the ring networks 23, a setting of a new VLAN becomes available. Therefore, a configuration of the ring networks 23, which utilizes pieces of VLAN information, becomes available. This indicates a virtual duplex configuration utilizing VLANs, for example.

In addition, as the assignment of a new VLAN, there are a method in which the transmission device 200 on a transmitting side preliminarily stores in the second flag and a method for storing in a signal at a time of coupling the ring network 23b in step S23, for example.

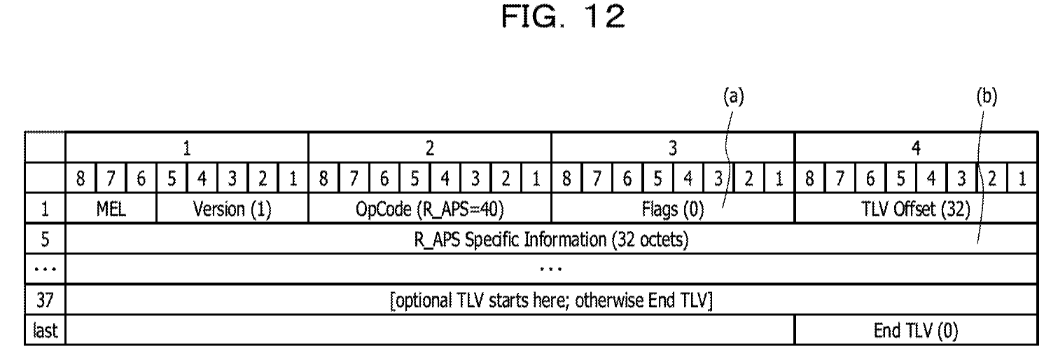

Here, a storage position of a flag and so forth will be described by using an example of a frame format of a signal in FIG. 12. The frame format of a signal illustrated in FIG. 12 is an automatic protection switching (APS) format specified by G.8032.

By using two unused bits of Flags (0) in (a) in FIG. 12, the storage location of the flag is able to be realized. In addition, the NR information corresponds to R-APS specific information (32 octets) in (b) in FIG. 12.

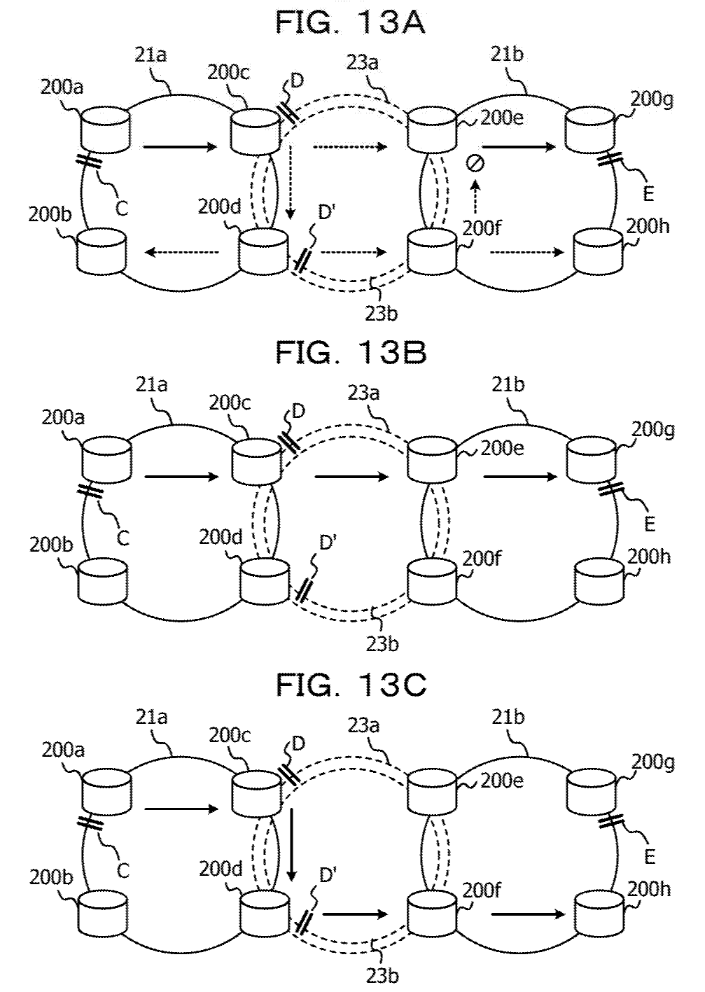

Next, an operation utilizing the ring networks 23 formed for respective pieces of VLAN information will be described by using FIGS. 13A, 13B and 13C. Note that, regarding owners of respective ring networks, it is assumed that the transmission device 200a is an owner of the ring network 21a, the transmission device 200g is an owner of the ring network 21b, and the transmission device 200c is an owner of the ring network 23a. In addition, regarding the ring network 23b, the transmission device 200d becomes an owner, based on the flowchart in FIG. 11.

FIGS. 13A, 13B and 13C are diagrams for explaining a case of transmitting by using a flooding method.

FIG. 13A illustrates a case where the transmission devices 200 each transmit based on the flooding method and the transmission device 200a transmits a signal to the transmission device 200g or the transmission device 200h. In other words, FIG. 13A illustrates directions of signals transmitted by the respective transmission devices 200 in a case where a communication path from the transmission device 200a to the transmission device 200g or the transmission device 200h is not established.

In addition, solid lines in FIG. 13A indicate a case of transmission in only one direction, and dotted lines indicate a case of transmission in directions.

Since the blocking port (C) exists in the direction of the transmission device 200b, the transmission device 200a only transmits to the transmission device 200c.

Upon receiving a signal from the transmission device 200a, the transmission device 200c transmits, to the transmission device 200e, a signal to which the second VLAN information is assigned, and the transmission device 200c transmits the received signal to the transmission device 200d.

Here, by using FIG. 9, an operation of the transmission device 200c will be described. Note that, in the description, the interface card 220a in the functional block diagram in FIG. 9 is coupled to the transmission device 200a, the interface card 220b therein is coupled to the transmission device 200d, and the interface card 220c therein is coupled to the transmission device 200e.

First, in a case where the reception unit 221a receives a signal, the judgment unit 222a judges the signal. Note that the judgment unit 222a references, for example, destination information of the signal and judges whether being established as a communication path. Since no blocking port exists on a transmission device 200a side, the filter unit 223a transfers the signal to the switching unit 231 without change. The switching unit 231 outputs the signal to the filter unit 226b (within the interface card 220b) and the branching unit 227c (within the interface card 220c). Note that since the signal is output to the two interface cards 220 at this time, the switching unit 231 makes and transfers duplicate copies of the signal to the respective two interface cards 220.

Since no blocking port exists on a transmission device 200d side, the filter unit 226b transfers the signal to the transmission processing unit 225b without change. The transmission processing unit 225b performs processing (for example, assignment of OAM information) for transmitting to the transmission device 200d and transfers to the transmission unit 224b. The transmission unit 224b transmits the signal to the transmission device 200d.

In addition, in a case where the signal is transferred by the switching unit 231, the branching unit 227c makes duplicate copies of the signal and assigns pieces of information of different VLANs thereto, thereby transferring the signals to the respective filter units 226c-1 and 226c-2.

The filter unit 226c-1 corresponds to the ring network 23a and includes the blocking port (D) on a transmission device 200e side in the ring network 23a. Therefore, the filter unit 226c-1 does not transfer the signal to the transmission processing unit 225c. On the other hand, the filter unit 226c-2 corresponds to the ring network 23b, and no blocking port exists on a transmission device 200e side in the ring network 23b. Therefore, the filter unit 226c-2 transfers the signal to the transmission processing unit 225c. The transmission processing unit 225c performs processing (for example, assignment of OAM information) for transmitting to the transmission device 200e and transfers to the transmission unit 224c. The transmission unit 224c transmits the signal to the transmission device 200d via the ring network 23b.

The processing explained in the above description is performed by the transmission device 200c, and transmission from the transmission units 224 in the interface cards 220 other than the interface card 220 corresponding to the reception unit 221 that performs reception becomes available, based on the flooding method.

Returning to FIG. 13A, the transmission device 200d transmits, to the transmission device 200b and the transmission device 200f, the signal received from the transmission device 200c.

Note that since the blocking port (C) exists, transmission of a signal from the transmission device 200b to the transmission device 200a is not performed. Note that since the transmission device 200a serving as an owner manages the blocking port (C) in the ring network 21a, actually the signal is transmitted to the transmission device 200a by the transmission device 200b and a corresponding one of the filter units 223 performs blocking in a case where the transmission device 200a receives the signal.

In addition, at a time of transmitting to the transmission device 200f, the transmission device 200d performs control (control in the interface card 220c) described in the transmission device 200c and transmits by using the ring network 23a. In other words, a signal is transmitted to the transmission device 200f by using the VLAN information (the first VLAN information corresponding to the ring network 23a) different from that at a time when the transmission device 200c transmits the signal to the transmission device 200e.

Upon receiving the signal from the transmission device 200d, the transmission device 200f transmits the received signal to the transmission device 200e and the transmission device 200h.

Note that since the blocking port (E) exists, transmission of a signal from the transmission device 200h to the transmission device 200g is not performed.

The transmission device 200e transmits, to the transmission device 200g, the signal received from the transmission device 200c. In addition, the signal from the transmission device 200f is not transmitted while being received.

An operation of the transmission device 200e will be described in detail. Note that, in the functional block diagram in FIG. 9, regarding the transmission device 200e, the interface card 220a is coupled to the transmission device 200g, the interface card 220b is coupled to the transmission device 200f, and the interface card 220c is coupled to the transmission device 200c.

Upon receiving a signal from the transmission device 200c, the reception unit 221c transfers the signal to the judgment unit 222c. The judgment unit 222c judges the signal and sends a result thereof to the control unit 215. In addition, the judgment unit 222c transfers the signal to the filter unit 223c-1 or the filter unit 223c-2, in accordance with the information of a VLAN, assigned to the signal. Note that the filter unit 223c-1 corresponds to a VLAN corresponding to the ring network 23a and the filter unit 223c-2 corresponds to a VLAN corresponding to the ring network 23b. Note that since the signal is a signal received (received with the ring network 23b as a communication path) from the transmission device 200c, the transmission device 200e transfers the signal to the filter unit 223c-2.

Since there is no control of a blocking port, the filter unit 223c-2 changes a VLAN and transfers to the switching unit 231.

In addition, in accordance with information (for example, VLAN information, a source address (a source address), and a destination address (a destination address)) from the judgment unit 222c, the control unit 215 controls the filter unit 223b and the filter unit 226b or controls the switching unit 231. Specifically, control is performed so that a source address and a destination address of the signal received by the reception unit 221c are stored in the storage unit 216 and so that the same signal (a signal having the same source address and the same destination address) is not transferred in a case of receiving the same signal from another interface.

This avoids the congestion of the signal by controlling the filter unit 223b and the filter unit 226b or controlling the switching unit 231 in a case of receiving via the ring network 23b (a ring network utilizing a signal of a VLAN different from normal), in addition to normal control of a blocking port.

Note that, in the control of the filter unit 226b or the switching unit 231, one of the two only has to be controlled and in a case of controlling the switching unit 231, control is performed so that a signal is only transferred to the interface card 220a.

In addition, in a case of controlling the filter unit 226b, a corresponding signal is subjected to filtering, and no signal is transferred to the transmission processing unit 225b.

In a case where such control is performed and the reception unit 220b receives the signal from the transmission device 200f, the signal is judged by the judgment unit 222b, and, based on control from the control unit 215, the signal is subjected to filtering by the filter unit 223b, thereby enabling congestion to be avoided.

In a case where, as described above, the transmission device 200a transmits the signal to the transmission device 200g or the transmission device 200h by using the flooding method, the transmission devices 200 that relay the signal along the paths and the transmission device 200 that receives the signal each store, in the storage unit 226, a relationship between a port (one of the interface cards 220), a transmission source, and the VLAN information.

In the same way, upon receiving, from each of the transmission device 200g and the transmission device 200h, a signal addressed to the transmission device 200a, communication paths are established, and in subsequent communication, a signal is transmitted by using a communication path illustrated in FIG. 13B or FIG. 13C. Note that FIG. 13B and FIG. 13C are diagrams illustrating a case where communication routes are established at a time when the transmission device 200a transmits a signal to the transmission device 200g and at a time when the transmission device 200a transmits a signal to the transmission device 200h, respectively. As understood from FIG. 13B and FIG. 13C, it is understood that different communication paths are used in the ring networks 23 at a time of transmitting signals to the respective transmission device 200g and transmission device 200h.

In this way, by using pieces of VLAN information, communication paths in the ring networks 23 become able to be established.

Note that, in a case where a failure related to one of the transmission devices 200 configuring the ring networks 23, switching to a single piece of VLAN information is performed (alternatively, all pieces of VLAN information are erased), and furthermore, pieces of related information such as destinations and transmission destination communication paths, stored in the storage unit 216, are erased. In other words, the virtual double coupling is cancelled, and an operation as a ring network in which a failure point is set to a blocking port is performed.

As described above, in the third embodiment, by causing the ring networks 23 coupling the ring network 21a and the ring network 21b to each other to have a duplex configuration, it becomes possible to effectively utilize communication paths coupling the transmission devices 200 to each other.

### First Example of Modification to Third Embodiment

In the third embodiment, the ring networks 23 coupling the ring network 21a and the ring network 21b to each other is described in a case where the same number of transmission devices 200 are used in each of the ring networks 21.

Here, a case where a different number of transmission devices 200 are used in each of the ring networks 21 will be described.

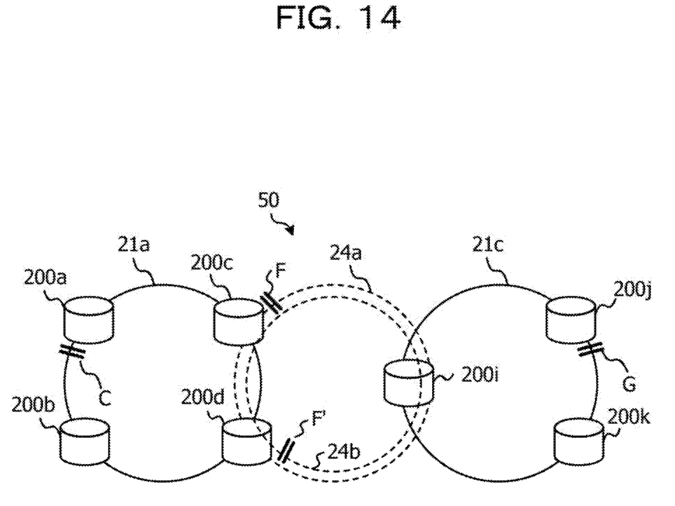

FIG. 14 illustrates the network 50 in the first example of a modification to the third embodiment. The network 50 includes the ring network 21a, a ring network 21c, a ring network 24a, and a ring network 24b. Note that the ring network 24a and the ring network 24b are distinguished from each other by using the VLAN information and are ring networks virtually having a duplex configuration. In other words, a network in which a physical line is used by VLANs is illustrated. In addition, in a case of not being distinguished from each other, the ring network 21a and the ring network 21c are simply described as ring networks 21. In addition, in a case of not being distinguished from each other, the ring network 24a and the ring network 24b are simply described as ring networks 24. Note that the same symbol is assigned to an element having the same configuration as that in the network 40, and the description thereof will be omitted. In addition, in a case of not being distinguished from one another, the transmission devices 200a to 200d and transmission devices 200i to 200k are simply described as transmission devices 200.

The ring network 21c includes the transmission devices 200i to 200k. Note that the transmission device 200j and the transmission device 200k are the same as the transmission device 200g and the transmission device 200h, respectively, in FIG. 8. In addition, in the ring network 21c, a corresponding port of the transmission device 200j is defined as a blocking port (G) between the transmission device 200j and the transmission device 200k, and communication between the transmission device 200j and the transmission device 200k is stopped.

The ring networks 24a and 24b include the transmission devices 200c, 200d, and 200i. In the ring networks 24a and 24b, communication between the ring network 21a and the ring network 21c is considered to be performed between the transmission device 200c and the transmission device 200i or between the transmission device 200d and the transmission device 200i.

In addition, in the ring network 24a, the transmission device 200c forms a blocking port (F) (corresponding to the first VLAN information) between the transmission device 200c and the transmission device 200i, thereby stopping communication between the transmission device 200c and the transmission device 200i. In addition, in the ring network 24b, the transmission device 200d forms a blocking port (F′) (corresponding to the second VLAN information) between the transmission device 200d and the transmission device 200i, thereby stopping communication between the transmission device 200d and the transmission device 200i.

Note that the transmission device 200i includes a total of four interface cards 220 including two interface cards 220 (each corresponding to the interface card 220c in FIG. 9) that each perform communication between the Sub-Rings and two interface cards 220 (each corresponding to the interface card 220a) that each perform communication between the Major-Rings.

As described in the third embodiment, in such a network 50, by causing the Sub-Rings to have a duplex configuration, it is possible to effectively utilize bands that are unused due to blocking.

### Second Example of Modification to Third Embodiment

The third embodiment illustrates a method in which a different blocking point is used for each of the pieces of VLAN information in the Sub-Rings coupling the Major-Rings to each other, thereby effectively utilizing bands.

In the second example of a modification to the third embodiment, a case where a different blocking point is applied to each of pieces of VLAN information in the Major-Rings will be described.

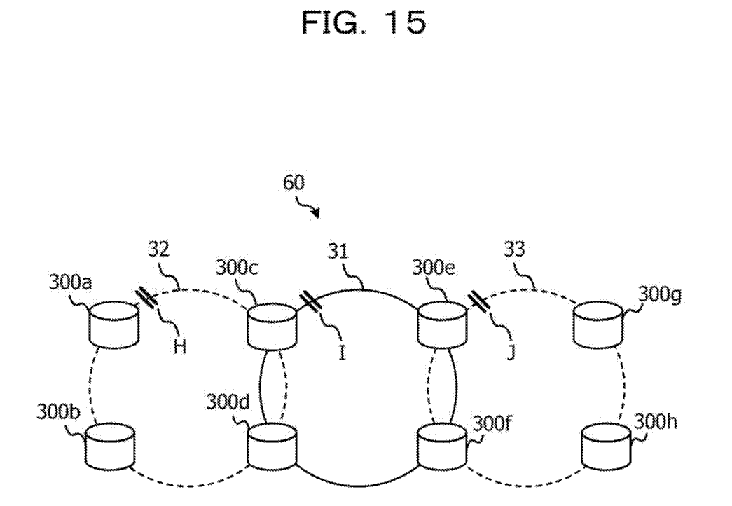

FIG. 15 illustrates an example of a configuration of the network 60 configured by a ring network (a Major-Ring) coupling ring networks (Sub-Rings) to each other. The network 60 includes a ring network (the Major-Ring) 31, a ring network 32 (one of the Sub-Rings), and a ring network 33 (the other of the Sub-Rings). In addition, it is assumed that each of the ring network 32 and the ring network 33 is further coupled to another Major-Ring. Accordingly, a line between transmission devices 300a and 300b and a line between transmission devices 300g and 300h are each the same line (a Virtual Link: VL) as that of a corresponding one of the other Major-Rings and are each difficult to use as a blocking port in a case of not being used by a blocking port by the corresponding one of the other Major-Rings.

Note that the ring network 31 is configured by transmission devices 300c to 300f, the ring network 32 is configured by the transmission devices 300a to 300d, and the ring network 33 is configured by the transmission devices 300e to 300h.

In addition, regarding blocking ports of the respective ring networks, the ring network 31 includes a blocking port (corresponding to a blocking port (I)) in the transmission device 300c, the ring network 32 includes a blocking port (corresponding to a blocking port (H)) in the transmission device 300a, and the ring network 33 includes a blocking port (corresponding to a blocking port (J)) in the transmission device 300e.

Note that the transmission devices 300 each have the same configuration as those of the transmission devices 200 described in the third embodiment and the interface cards 220 vary depending on coupling states.

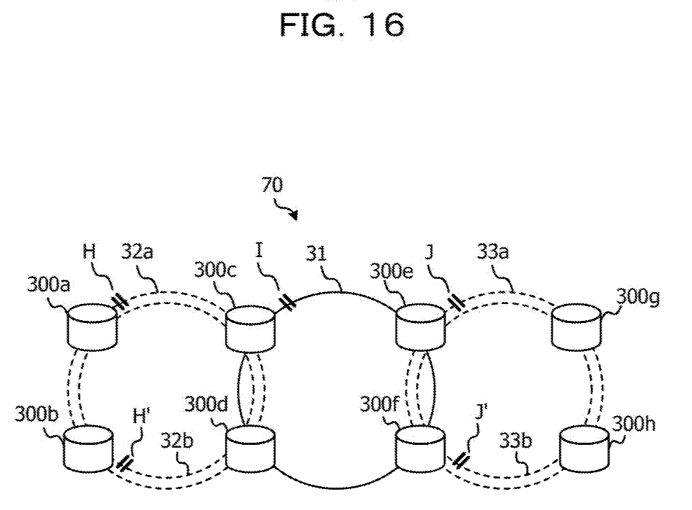

Here, FIG. 16 illustrates the network 70 in which a blocking port is applied to each of the ring networks 32 and 33 for each of different pieces of VLAN information by using the method described in the third embodiment. The network 70 includes the ring network 31, ring networks 32a and 32b, and ring networks 33a and 33b. Note that the ring network 32a and the ring network 32b are obtained by configuring the ring network 32 in FIG. 15 by using pieces of VLAN information and are simply described as ring networks 32 in a case of not being distinguished from each other. In addition, in the same way, the ring networks 33a and 33b are simply described as ring networks 33 in a case of not being distinguished from each other. In addition, regarding blocking ports of the individual ring networks, the ring network 32a includes a blocking port (corresponding to the blocking port (H)) in the transmission device 300a, the ring network 32b includes a blocking port (corresponding to a blocking port (H′)) in the transmission device 300b, the ring network 33a includes a blocking port (corresponding to the blocking port (J)) in the transmission device 300e, and the ring network 33b includes a blocking port (corresponding to a blocking port (J′)) in the transmission device 300f.

As described above, in both the Sub-Rings installed in the Major-Ring, VLANs are used based on the method described in the third embodiment, and blocking ports of the respective VLANs are used for each of the Sub-Rings, thereby enabling communication bands to be effectively used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of transmission of a signal using a ring network that includes a plurality of transmission devices, any one transmission device of the plurality of transmission devices being set as a first blocking portion, and any another transmission device of the plurality of transmission devices being set as a second blocking portion, the method comprising:
receiving, by a first transmission device of the plurality of transmission devices, a first signal;
setting, by the first transmission device, first information in the first signal; and
transmitting, from the first transmission device to a second transmission device of the plurality of transmission devices, the first signal in which the first information is set, wherein
when a value of the first information is a first value, the first blocking portion passes the first signal and the second blocking portion blocks the first signal, and
when the value of the first information is a second value, the second blocking portion passes the first signal and the first blocking portion blocks the first signal.

2. The method according to claim 1, further comprising:
transmitting, from the first transmission device to a third transmission device included in the ring network, the first signal in which the first information is set.

3. The method according to claim 2, wherein
the first blocking portion is set between the first transmission device and the second transmission device, and
in the setting of the first information in the first signal, the first transmission device sets, in the first signal, the first information having the first value.

4. The method according to claim 3, wherein
the second transmission device is adjacent to the first transmission device in a first direction of the ring network, and
the third transmission device is adjacent to the first transmission device in a second direction that is a direction opposite to the first direction of the ring network.

5. The method according to claim 4, further comprising:
blocking, at the second blocking portion, the first signal in which the first information having the first value is set and that is transmitted to the third transmission device.

6. The method according to claim 4, wherein
the first transmission device includes a first port coupled to the second transmission device, and a second port coupled to the third transmission device, and
the first port functions as the first blocking portion.

7. The method according to claim 6, further comprising:
registering, in the first transmission device, association information in which one of the first port and the second port is associated with first address information indicating an address of a destination device of the first signal.

8. The method according to claim 7, wherein
in the registering of the association information, the association information in which the first address information and the first port are associated with each other is registered in the first transmission device when the first transmission device receives, using the first port, a second signal transmitted by the destination device of the first signal, and
when the first transmission device receives the second signal having a destination of the first address after the association information in which the first address information and the first port are associated with each other is registered in the first transmission device, the first transmission device outputs the second signal using the first port and does not output using the second port.

9. The method according to claim 8, wherein
when the first transmission device receives the second signal before the association information is registered in the first transmission device, the first transmission device outputs the second signal using both the first port and the second port.

10. The method according to claim 1, wherein
the first information is virtual local area network (VLAN) information.

11. The method according to claim 2, further comprising:
generating, by the first transmission device, a duplicate signal by duplicating the first signal;
setting, by the first transmission device, the first information having the second value in the duplicate signal; and
transmitting, from the first transmission device to the second transmission device and the third transmission device, the first signal in which the first information having the first value is set, and the duplicate signal in which the first information having the second value is set.

12. The method according to claim 1, wherein
the plurality of transmission devices other than the first transmission device each includes a function of generating the first information.

13. The method according to claim 12, further comprising:
receiving, by the first transmission device, a first control signal indicating that no failure occurs in ring network; and
transmitting, from the first transmission device to the plurality of transmission devices other than the first transmission device, a second control signal indicating permission of generating the first information.

14. The method according to claim 12, further comprising:
receiving, by the first transmission device, a third control signal indicating that a failure occurs in the ring network; and
transmitting, from the first transmission device to the plurality of transmission devices other than the first transmission device, a fourth control signal indicating prohibition of generating the first information.

15. The method according to claim 2, wherein
the first transmission device and the third transmission device are included in another plurality of transmission devices included in another ring network,
the second transmission device is not included in the another plurality of transmission devices,
the first signal is transmitted to the first transmission device by a fourth transmission device included in the second plurality of transmission devices, and
when the destination device of the first signal is not included in the second plurality of transmission devices, the first signal is transmitted to the third transmission device by the first transmission device.

16. A ring network comprising:
a plurality of transmission devices each of which including circuitry, any one transmission device of the plurality of transmission devices being set as a first blocking portion, any another transmission device of the plurality of transmission devices being set as a second blocking portion, and a first transmission device of the plurality of transmission devices being configured to receive a first signal, to set first information in the first signal, and to transmit, to a second transmission device of the plurality of transmission devices, the first signal in which the first information is set, wherein
when a value of the first information is a first value, the first blocking portion passes the first signal and the second blocking portion blocks the first signal, and
when the value of the first information is a second value, the second blocking portion passes the first signal and the first blocking portion blocks the first signal.

17. The ring network according to claim 16, wherein
the first transmission device is configured to transmit, to a third transmission device included in the plurality of transmission devices, the first signal in which the first information is set.

18. The ring network according to claim 17, wherein
the first blocking portion is set between the first transmission device and the second transmission device, and
the first transmission device is configured to set, in the first signal, the first information having the first value.

19. The ring network according to claim 18, wherein
the second transmission device is adjacent to the first transmission device in a first direction of the ring network, and
the third transmission device is adjacent to the first transmission device in a second direction that is a direction opposite to the first direction of the ring network.

20. The ring network according to claim 19, wherein:
the first signal in which the first information having the first value is set and that is transmitted to the third transmission device is blocked at the second blocking portion.
